(19) United States
(12) Patent Application Publication
(10) Pub. No.: US 2025/0094202 A1
(43) Pub. Date: Mar. 20, 2025

(54) UPGRADING SOFTWARE RUNNING IN HOSTS OF A VIRTUAL COMPUTING INFRASTRUCTURE

(71) Applicant: VMware, Inc., Palo Alto, CA (US)

(72) Inventors: Abhijith Umesh, Sunnyvale, CA (US); Bharath Siddapur Hemashekar, Santa Clara, CA (US)

(21) Appl. No.: 18/471,104

(22) Filed: Sep. 20, 2023

(51) Int. Cl. G06F 9/455

(52) U.S. Cl. CPC G06F 9/45558; G06F 2009/4557

(57) ABSTRACT

A method of upgrading a cluster of hosts, where the hosts are running at least one workload designated as critical, includes the steps of: adding a host that has been upgraded to the cluster of hosts, selecting one of the hosts for upgrade, determining whether any of the workloads running in the selected host are designated as critical, migrating all of the workloads from the selected host that are designated as critical to the added host, and migrating each of the workloads from the selected host that are not designated as critical to a selected one of the hosts of the cluster.

### BACKGROUND

In a software-defined data center (SDDC), virtual infrastructure, which includes virtual machines (VMs) and virtualized storage and networking resources, is provisioned from hardware infrastructure that includes a plurality of host computers (hereinafter also referred to simply as “hosts”), storage devices, and networking devices. The provisioning of the virtual infrastructure is carried out by SDDC management software that is deployed on management appliances, such as a VMware vCenter Server® appliance and a VMware NSX® appliance, from VMware, Inc. The SDDC management software communicates with virtualization software (e.g., a hypervisor) installed in the hosts to manage the virtual infrastructure.

The virtualization software installed in the hosts undergo frequent upgrades so that new features developed for the SDDC can be deployed onto the virtual infrastructure. To achieve minimal downtime, a logical group of hosts of the SDDC, commonly referred to as a cluster, undergo upgrades on a rolling basis, and if there are any VMs running on a host being upgraded, those VMs are migrated to other hosts of the cluster.

To ensure that there are sufficient resources to support the migration of the VMs, at the beginning of the upgrade process, a new host that has the upgraded virtualization software installed therein is added to the cluster. Thus, during the upgrade process, the number of hosts of the cluster is temporarily increased by one. At the end of the upgrade process, one of the hosts of the cluster is removed after VMs running thereon (if any) are migrated to the other hosts of the cluster.

In many cases, VMs of the cluster are migrated more than once during the upgrade process. In fact, some VMs undergo N+1 migrations, where N is the number of hosts of the cluster that are being upgraded. In many cases, migrating a VM multiple times is not a problem and is often necessary to achieve load balancing across the hosts during the upgrade process. However, the VMs experience some downtime during migration and, in some situations, reducing the number of migrations would be beneficial.

### SUMMARY

One or more embodiments provide a method of upgrading virtualization software installed in a cluster of hosts that reduces the number of VM migrations. In one embodiment, VMs that are running critical workloads, such as latency-sensitive workloads, are specially designated and are limited to only one migration during the upgrade process. In addition, VMs that are running critical workloads are identified and prepared for migration early in the upgrade process through in-app notifications that cause the VMs to be quiesced so that the time window for monitoring their migration can be shortened.

A method of upgrading a cluster of hosts according to an embodiment, where the hosts are running at least one workload designated as critical, includes the steps of: adding a host that has been upgraded to the cluster of hosts, selecting one of the hosts for upgrade, determining whether any of the workloads running in the selected host are designated as critical, migrating all of the workloads from the selected host that are designated as critical to the added host, and migrating each of the workloads from the selected host that are not designated as critical to a selected one of the hosts of the cluster.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a conceptual block diagram of a cluster of hosts for a software-defined data center that is distributed across two availability zones located in different customer environments, and managed through a cloud platform, according to embodiments.

FIG. 2 is a flow diagram of an upgrade process carried out by the cloud platform.

FIGS. 3A-3F are conceptual diagrams that depict the upgrade process involving virtual machines with critical workloads.

FIGS. 4A-4E are conceptual diagrams that depict the upgrade process involving virtual machines that are deployed as an active-passive pair.

FIGS. 5A-5G are conceptual diagrams that depict the upgrade process for hosts of a stretched cluster that spans two availability zones.

FIGS. 6A-6D are conceptual diagrams that depict the upgrade process involving virtual machines of a clustered application.

### DETAILED DESCRIPTION

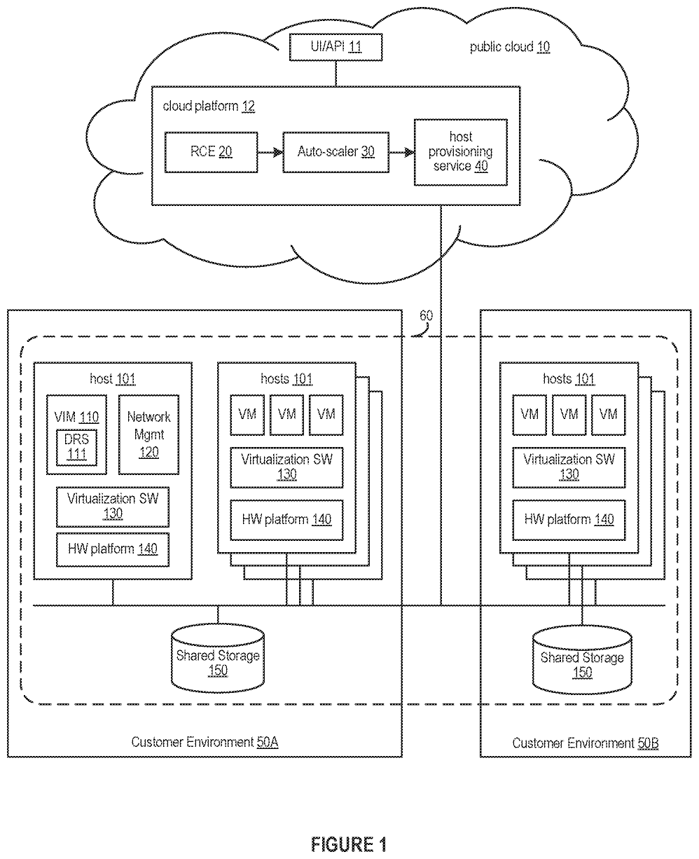

FIG. 1 is a conceptual block diagram of a cluster of hosts for an SDDC that is distributed across two availability zones located in different customer environments, customer environment 50A and customer environment 50B, and managed through a cloud platform 12, which is implemented in a public cloud 10. A user interface (UI) or an application programming interface (API) of cloud platform 12 is depicted in FIG. 1 as UI/API 11. As used herein, a “customer environment” means one or more private data centers managed by the customer, which is commonly referred to as “on-prem,” a private cloud managed by the customer, a public cloud managed for the customer by another organization, or any combination of these.

In the embodiments described herein, software upgrades are managed through a release coordination engine (RCE) 20. RCE 20 tracks versions of software, including virtualization software, installed in the hosts, and upgrades to the software that become available. The user (e.g., the customer) is notified of the software upgrades through UI/API 11 and the user may trigger the upgrade process through UI/API 11.

The services of cloud platform 12 that are involved in the upgrade process include auto-scaler 30 and host provisioning service 40. Auto-scaler 30 manages the overall upgrade process, and host provisioning service 40 communicates with control planes in each of the customer environments involved in the upgrade process to add the hosts. In one embodiment, the software components of cloud platform 12 depicted herein are each a microservice that is implemented as a container image executed on a virtual infrastructure of public cloud 10.

In FIG. 1, the hosts that are undergoing an upgrade belong to a stretched cluster 60 that spans two customer environments. Stretched cluster includes a plurality of hosts 101. In the embodiment illustrated in FIG. 1, some of hosts 101 are in customer environment 50A and some of hosts 101 are in customer environment 50B. Each host 101 includes a hardware platform 140 that includes one or more processors (e.g., CPUs), system memory (e.g., static and/or dynamic random access memory), one or more network interface controllers, and a storage interface (e.g., host bus adapter) for connection to a storage area network and/or a local storage device, such as a hard disk drive or a solid state drive.

On each host 101, virtualization software 130 (e.g., hypervisor) is installed on top of hardware platform 140. Virtualization software 130 is a software layer that provides an execution environment within which multiple VMs are concurrently instantiated and executed. The execution environment of each VM includes virtualized components analogous to the components in hardware platform 140. In this manner, virtualization software 130 abstracts the VMs from physical hardware while enabling the VMs to share the physical resources of hardware platform 140. As a result of this abstraction, each VM operates as though it has its own dedicated computing resources.

In the embodiments, each VM may be tagged as running critical workloads, part of a clustered application, or part of an active-passive pair. Any tagging mechanism may be used. In one example, each VM has a tag field in the configuration file thereof, and a VM that is running a critical workload would have a ‘critical’ designation in its tag field. In addition, VMs that are part of a clustered application would have tags that uniquely identifies the clustered application that the VM is a part of, and VMs that are part of an active-passive pair would have tags that has been uniquely assigned to the pair.

Virtual disk files and configuration files for the VMs of stretched cluster 60 are stored in shared storage 150. Shared storage 150 is managed by a virtual infrastructure management (VIM) server 110 (e.g., the VMware vCenter Server® appliance), as storage for stretched cluster 60 and may be a physical storage device, e.g., storage array, or a virtual storage area network (VSAN) device, which is provisioned from local storage devices of hosts 101.

The two customer environments are provisioned as different availability zones. An availability zone is a fault domain. Using two availability zones can improve availability of management components running the SDDC, minimize downtime of services, and improve service level agreements (SLAs). Availability zones may be located within the same data center, but in different racks, chassis or rooms, or in different data centers with low-latency high-speed links connecting them. The provisioning of a stretched cluster that spans multiple availability zones is further described in U.S. patent application Ser. No. 16/281,128, filed Feb. 21, 2019, the entire contents of which are incorporated by reference herein.

Stretched cluster 60 is managed by management appliances, which include VIM server 110 for overall management of the virtual infrastructure, and a network management server (e.g., the VMware NSX® appliance) for management of virtual networks of stretched cluster 60. In the embodiments, both management appliances are implemented as virtual machines running in one of hosts 101 of stretched cluster 60.

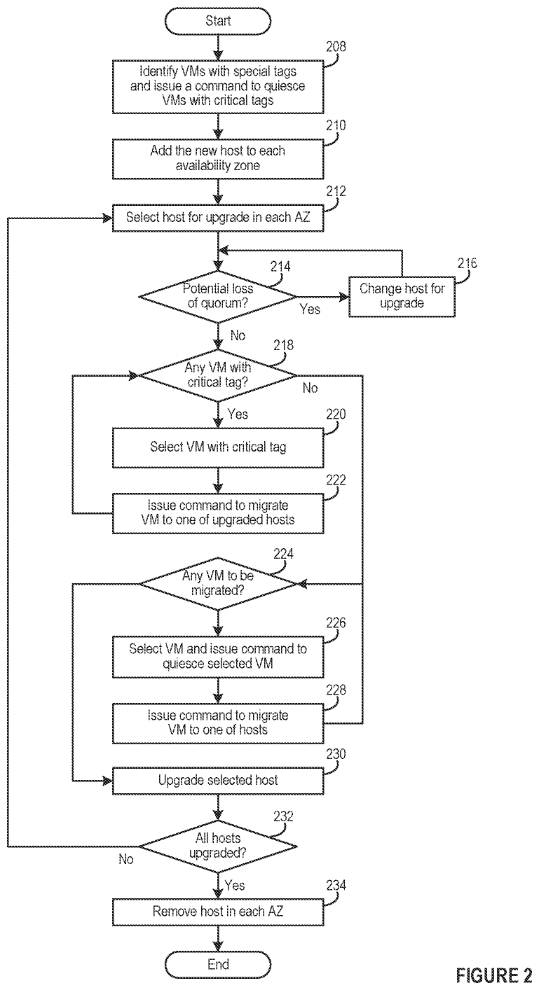

FIG. 2 is a flow diagram of an upgrade process carried out by cloud platform 12. The upgrade process is triggered by a user request made through UI/API 11 to initiate the upgrade process. In response to the user request, RCE 20 provides the details of target software manifest (e.g., new version of virtualization software 130) to be installed in hosts 101 of stretched cluster 60 to auto-scaler 30 to trigger the start of the upgrade process. At step 208, auto-scaler 30 communicates with VIM server 110 to identify VMs with special tags running in hosts 101 of stretched cluster 60. The special tags include a critical tag that identifies the VM as running latency-sensitive and other critical workloads. These workloads include those that implement network edge routing functions, voice-over-IP applications, and high-frequency trading applications. The special tags also include clustered application tags that identify VMs that are part of a clustered application, or active/passive tags that identify a pair of VMs as an active-passive pair. In addition, auto-scaler 30 at step 208 issues a command to VIM server 110 to quiesce the VMs with critical tags in preparation for migration. The quiesced VMs are still running but all input-and-output operations to and from it are suspended. VIM server 110 quiesces the VMs through in-app notifications. Because the quiesce times for the VMs may be different, VIM server 110 sends the in-app notifications to the VMs at different times so that all of the VMs will be quiesced at about the same time that is roughly aligned with when step 210 below would be completed.

At step 210, auto-scaler 30 issues a command to host provisioning service 40 to add a host with upgraded software to each availability zone across which stretched cluster 60 spans. In response, host provisioning service 40 communicates with control planes of the customer environments in which the availability zones have been created to add a new host with the upgraded software. Step 210 is carried out after step 208 to allow quiescing of the VMs with critical tags to complete during the period of time it takes for the host to be added to each availability zone.

After the new hosts have been added, auto-scaler 30 at step 212 selects a host for upgrade in each availability zone, and at step 214 determines whether or not there would be a potential loss of quorum as a result of the upgrade being performed on the selected hosts concurrently by checking to see if VMs that are part of the same clustered application are running in more than one of the selected hosts. For example, if there are three VMs across two availability zones that are executing the clustered application, and both hosts selected for upgrade in the two availability zones at step 212 are each running one of the three VMs, there would be a potential loss of quorum, e.g., if the VMs of the clustered application were migrated at the same time to the newly added hosts. Therefore, if there could be a loss of quorum as a result of the upgrade being performed on the selected hosts concurrently, the selection of one or more of the hosts is changed at step 216 and step 214 is performed again.

If it is determined at step 214 that there can be no potential loss of quorum, auto-scaler 30 initiates the process of the migrating VMs from the selected host in each availability zone. Migration of VMs having critical tags are carried out first one-by-one. Consequently, at step 218, auto-scaler 30 determines if any VMs in the selected host have critical tags. If so, auto-scaler 30 at step 220 selects one of the VMs with the critical tag and at step 222 issues a command to VIM server 110 to migrate the selected VM to one of the hosts in its availability zone that have been upgraded, which may be one of the new hosts added at step 210 or one of the hosts previously selected at step 212 that has been upgraded at step 230. In response, VIM server 110 employs distributed resource scheduler (DRS) 111 running therein to select one of the hosts of the cluster that have been upgraded as a migration destination and migrates the selected VM to the migration destination. The VM migration is carried out using techniques well-known in the art, including the one disclosed in U.S. Pat. No. 8,260,904, the entire contents of which are incorporated by reference herein. In addition, DRS 111 performs a selection of the hosts among a pool of candidate hosts according to a load balancing algorithm so that the selected VM is placed in a least-loaded one of the candidate hosts.

After all of the VMs having critical tags are migrated, the remaining VMs in the selected host(s) are carried out one-by-one. At step 224, auto-scaler 30 determines if there are any VMs remaining in the selected host. If so, at step 226, auto-scaler 30 selects one of the remaining VMs and issues a command to VIM server 110 to quiesce the selected VM in preparation for migration. Then, auto-scaler 30 at step 228 issues a command to VIM server 110 to migrate the selected VM to any one of the hosts in its availability zone including the new ones added at step 210. In response, VIM server 110 employs distributed resource scheduler (DRS) 111 running therein to select any one of the hosts of the cluster as a migration destination according to its load balancing algorithm described above and migrates the selected VM to the migration destination.

When step 230 is reached, the selected host in each availability zone may be upgraded because all VMs running therein have been migrated therefrom. Therefore, auto-scaler 30 at step 230 issues a command to host provisioning service 40 to upgrade the selected host. At step 232, auto-scaler 30 checks to see if there any hosts of stretched cluster 60 that have not yet been upgraded. If so, the upgrade process continues by returning to step 212 at which auto-scaler 30 further selects a host in each availability zone for upgrade. If there are no more hosts of stretched cluster 60 that have not yet been upgraded, auto-scaler 30 issues a command to host provisioning service 40 to remove a host from each availability zone.

In the description of the upgrade process given above, it is assumed that the cluster is a stretched cluster that spans two or more availability zones. The description of the upgrade process is also applicable to a normal cluster of hosts, where all hosts of the cluster are in a single availability zone. Further, more than one host may be added per availability zone. In such a case, more than one host are selected for upgrade and VMs running in the hosts selected for upgrade are migrated to their respective migration destinations determined by DRS 111 during the same migration window.

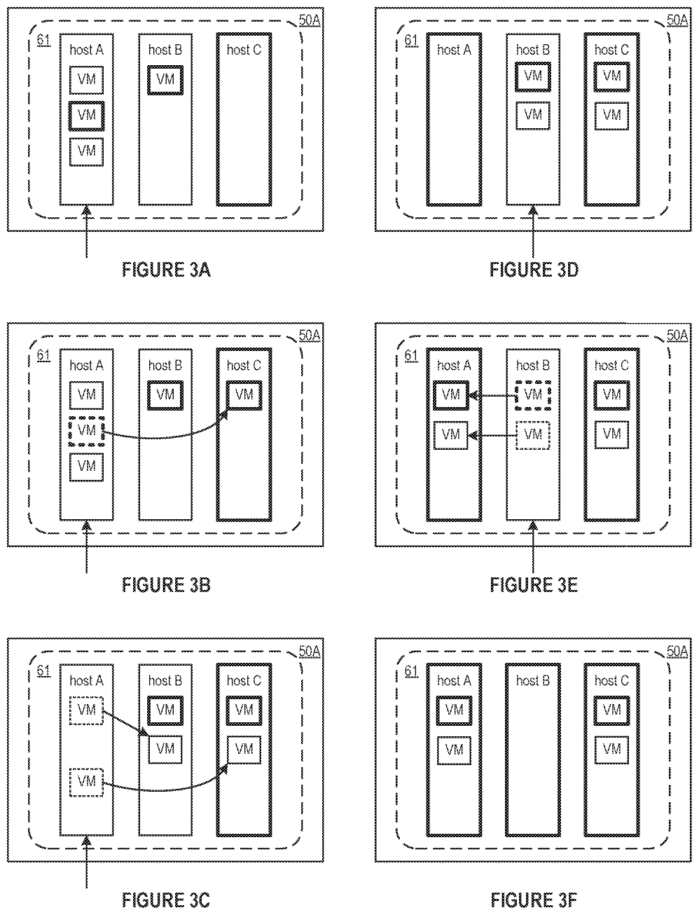

FIGS. 3A-3F are conceptual diagrams that depict the upgrade process involving virtual machines with critical workloads. In these diagrams, hosts that have been upgraded are depicted in bold lines. In addition, VM that have critical tags (also referred to herein as “critical VMs”) are depicted in bold lines, and VMs that have been migrated from their origin are depicted in dotted lines. FIGS. 3A-3F sequentially depict the state of the upgrade process and the upward arrow in each figure indicates the host that has been selected for upgrade.

The upgrade process in the example given in FIGS. 3A-3F is carried out in one customer environment 50A, and cluster 61 is a normal cluster that is provisioned in a single availability zone. For simplicity, cluster 61 in this example includes only two hosts, host A and host B, and a third host, host C, is added in connection with the upgrade process. As shown in FIG. 3A, the added host already has the upgraded software.

The upgrade process of FIGS. 3A-3F begins with the selection of host A as the host to be upgraded (see FIG. 3A). The critical VM from the selected host is then migrated to an upgraded host, host C, as depicted in FIG. 3B. After the critical VM is migrated, the remaining VMs are migrated, as depicted in FIG. 3C, to other hosts of cluster 61 selected by DRS 111. Then, as depicted in FIG. 3D, host A is upgraded and host B is selected as the next host to be upgraded. FIG. 3E depicts the migration of the VMs from host B to upgraded host A. Although not depicted, the critical VM running in host B is migrated first to host A and then the other VM running in host B is migrated to host A. Host A is selected by DRS 111 for both migrations based on its load balancing algorithm. FIG. 3F depicts the upgrade of host B. Subsequently, upgraded host B may remain as part of cluster 61 if utilization of resources of cluster 61 has increased during the upgrade process or is expected to increase, or may be removed from cluster 61 but maintained as a spare host. Further, if cluster 61 included one or more hosts with no critical VMs running therein, host B may be maintained (e.g., if its local storage has lots of data or it is tagged to be used in a particular way) and one of these other hosts may be removed after migrating VMs running therein to host B.

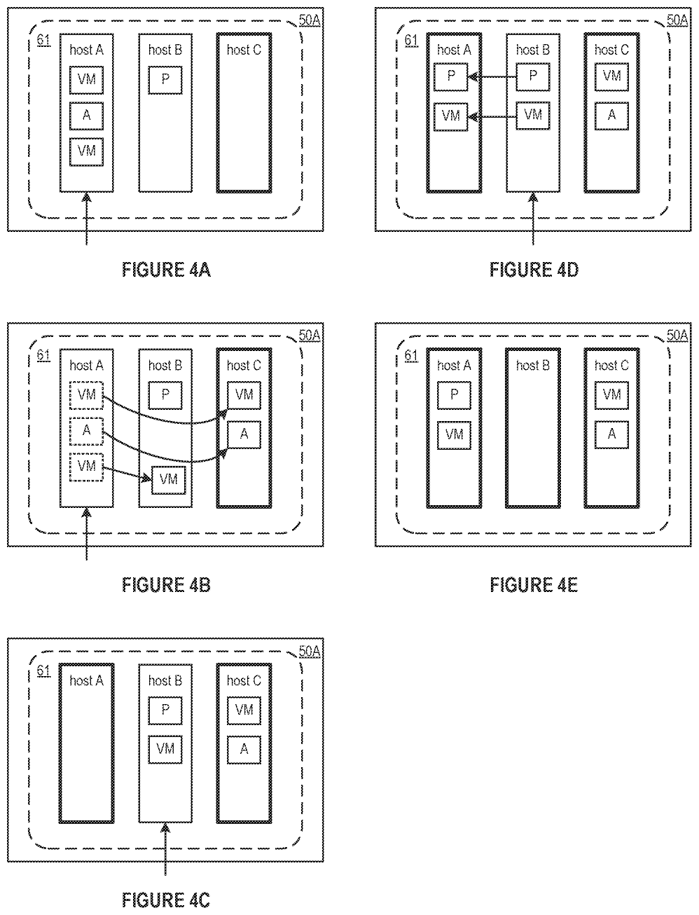

FIGS. 4A-4E are conceptual diagrams that depict the upgrade process involving virtual machines that are deployed as an active-passive pair. In these diagrams, hosts that have been upgraded are depicted in bold lines. In addition, VMs that are deployed as an active-passive pair are depicted as A for active VM and P for passive VM. Further, VMs that have been migrated from their origin are depicted in dotted lines. FIGS. 4A-4E sequentially depict the state of the upgrade process and the upward arrow in each figure indicates the host that has been selected for upgrade.

The upgrade process in the example given in FIGS. 4A-4E is carried out in one customer environment 50A, and cluster 61 is a normal cluster that is provisioned in a single availability zone. For simplicity, cluster 61 in this example includes only two hosts, host A and host B, and a third host, host C, is added in connection with the upgrade process. As shown in FIG. 4A, the added host already has the upgraded software.

The upgrade process of FIGS. 4A-4E begins with the selection of host A as the host to be upgraded (see FIG. 4A). The VMs from the selected host are then migrated to other hosts of cluster 61 selected by DRS 111. Host C is selected by DRS 111 as a migration destination for two VMs and host B for one VM based on its load balancing algorithm. Then, as depicted in FIG. 4C, host A is upgraded and host B is selected as the next host to be upgraded. FIG. 4D depicts the migration of the VMs from host B to host A. When the passive VM is selected for migration, host C is excluded from the list of possible migration destinations that DRS 111 can consider for the passive VM so as to prevent the active-passive pair from coalescing on the same host. For this reason, host A is the only migration destination for the passive VM. Host A is selected by DRS 111 for migrating the other VM based on its load balancing algorithm. FIG. 4E depicts the upgrade of host B. Subsequently, upgraded host B may be used in the same manner as upgraded host B of FIG. 3F described above.

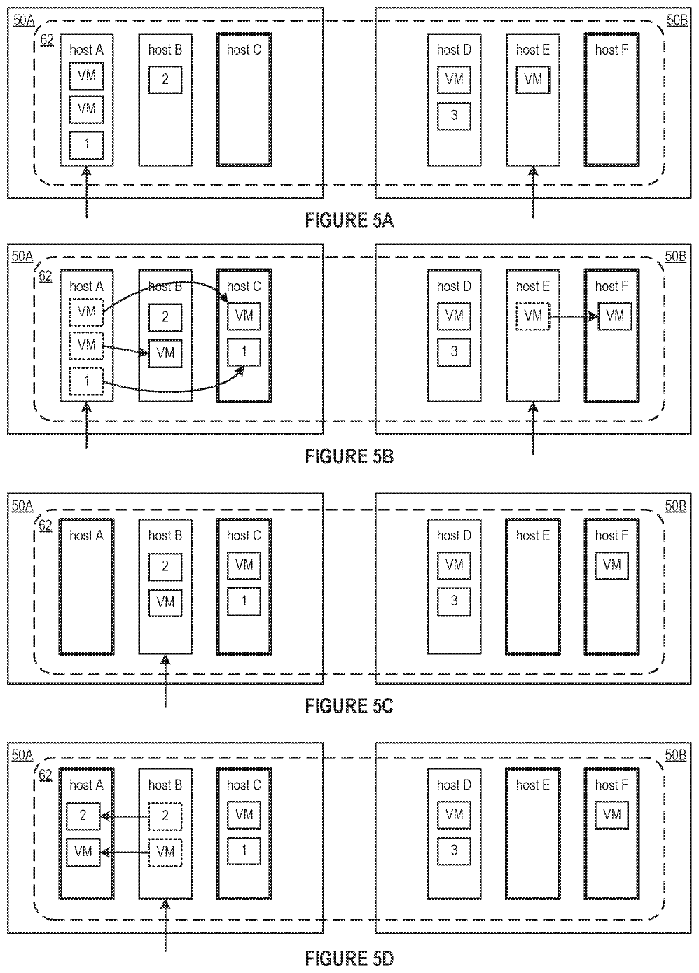

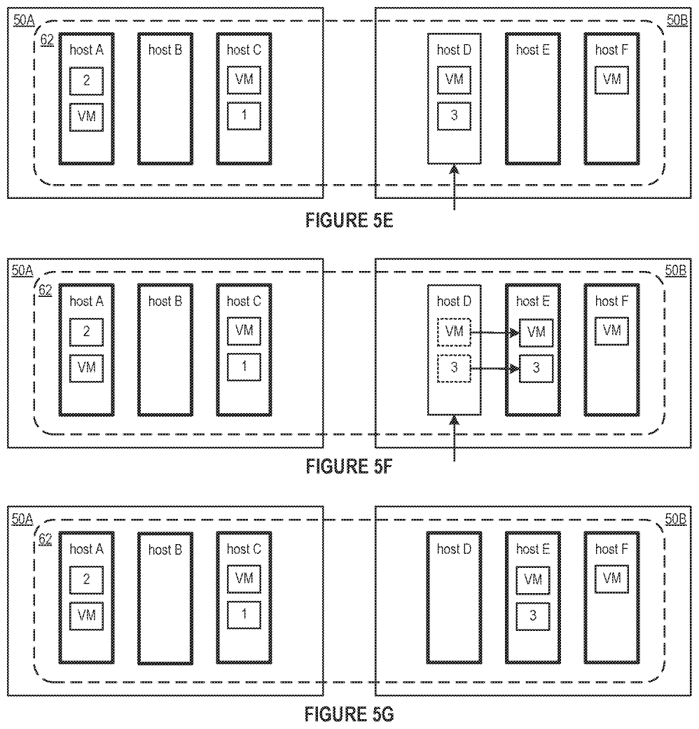

FIGS. 5A-5G are conceptual diagrams that depict the upgrade process for hosts of a stretched cluster that spans two availability zones. In these diagrams, hosts that have been upgraded are depicted in bold lines. In addition, it is assumed that a clustered application is running with three VM instances. These VM instances are depicted as 1, 2, and 3. Further, VMs that have been migrated from their origin are depicted in dotted lines. FIGS. 5A-5G sequentially depict the state of the upgrade process and the upward arrows in each figure indicates the host in each availability zone that has been selected for upgrade.

The upgrade process in the example given in FIGS. 5A-5G is carried out in two customer environments 50A and 50B, and cluster 62 is a stretched cluster that spans two availability zones. For simplicity, cluster 62 in this example includes only two hosts in each availability zone (hosts A and B in the first availability zone and hosts D and E in the second availability zone), and a third host (host C in the first availability zone and host F in the second availability zone) is added in each availability zone in connection with the upgrade process. As shown in FIG. 5A, the added host already has the upgraded software.

The upgrade process of FIGS. 5A-5G begins with the selection of host A in the first availability zone and host E in the second availability zone as the hosts to be upgraded (see FIG. 5A). Host D is initially selected for upgrade in the second availability zone but it is changed to host E because there would be a potential loss of quorum in the execution of the clustered application if host A and host D are selected for concurrent upgrades. The VMs from the selected host in the first availability zone are then migrated to other hosts of cluster 62 in the first availability zone selected by DRS 111. Similarly, the VMs from the selected host in the second availability zone are migrated to other hosts of cluster 62 in the second availability zone selected by DRS 111.

Then, as depicted in FIG. 5C, host A is upgraded and host B is selected as the next host to be upgraded in the first availability zone. Meanwhile, in the second availability zone, host E is upgraded but host D is not selected as the next host to be host to be upgraded in the second availability zone because there would be a potential loss of quorum in the execution of the clustered application. FIG. 5D depicts the migration of the VMs from host B to host A. Host A is selected by DRS 111 for migrating the VMs from host B based on its load balancing algorithm.

FIG. 5E depicts the upgrade of host B in the first availability zone, and the selection of host D for upgrade in the second availability zone. Then, as depicted in FIG. 5F, VMs are migrated from host D to host E in the second availability zone. Host E is selected by DRS 111 for migrating the VMs from host D based on its load balancing algorithm. FIG. 5G depicts the upgrade of host D in the second availability zone. Subsequently, upgraded hosts B and D may be used in the same manner as upgraded host B of FIG. 3F described above.

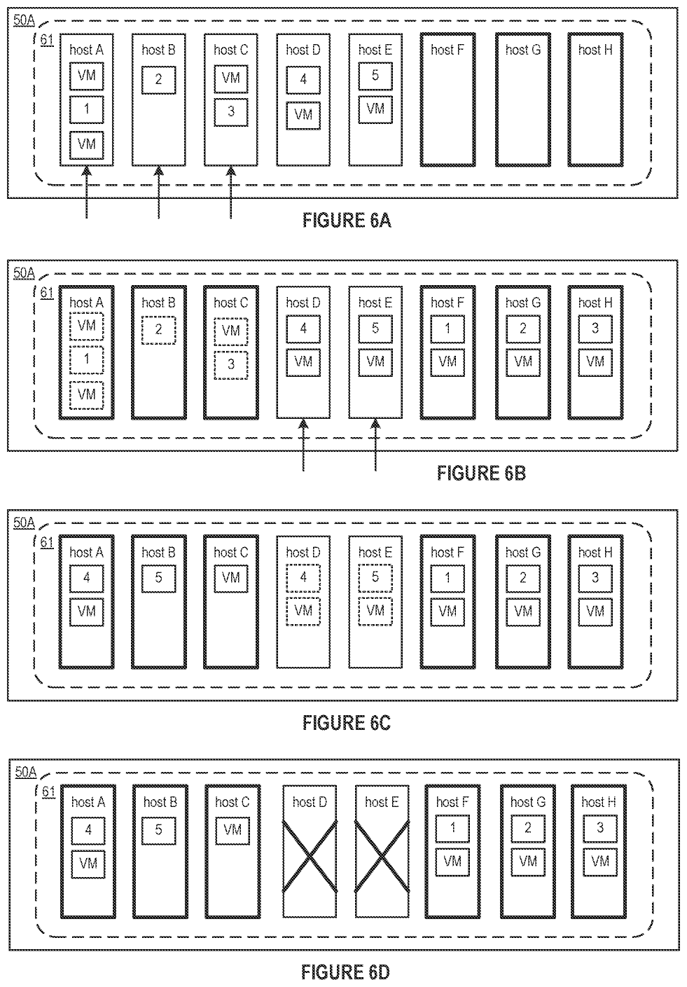

FIGS. 6A-6D are conceptual diagrams that depict the upgrade process involving virtual machines of a clustered application. In these diagrams, hosts that have been upgraded are depicted in bold lines. In addition, it is assumed that a clustered application is running with five VM instances. These VM instances are depicted as 1, 2, 3, 4, and 5. Further, VMs that have been migrated from their origin are depicted in dotted lines. FIGS. 6A-6D sequentially depict the state of the upgrade process and the upward arrows in each figure indicates the hosts that have been selected for upgrade.

The upgrade process in the example given in FIGS. 6A-6D is carried out in one customer environment 50A, and cluster 61 is a normal cluster that is provisioned in a single availability zone and includes five hosts, in each of which one VM instance of the clustered application is running. In the example given in FIGS. 6A-6D, auto-scaler 30 determines that three upgraded hosts should be added to support the upgrade process that is carried out with no potential loss of quorum and downtime, and to provide a deterministic window for the clustered application administrator to confirm that the clustered application is properly running at the beginning of the upgrade process. In general, the number of upgraded hosts that should be added is int(N/2)+1 where N is the number of VM instances of the clustered application. As shown in FIG. 6A, three hosts, host F, host G, and host H, which have already been upgraded, are added to cluster 61 to support the upgrade process.

The upgrade process of FIGS. 6A-6D begins with the selection of host A, host B, and host C as the hosts to be upgraded (see FIG. 6A). Then, as depicted in FIG. 6B, the VM instances of the clustered application running in host A, host B, and host C, are migrated to host F, host G, and host H, respectively. The other VMs running in host A, host B, and host C are migrated to host F (one), host G (one), and host H (one). Host F, host G, and host H are selected by DRS 111 as migration destinations for these other VMs based on its load balancing algorithm.

Then, host A, host B, and host C are upgraded, and host D and host E are selected as the next hosts to be upgraded (see FIG. 6B). Then, as depicted in FIG. 6C, the VM instances of the clustered application running in host D and host E are migrated to host A and host B, respectively. The other VMs running in host D and host E are migrated to host A (one) and host C (one). Host A and host C are selected by DRS 111 as migration destinations for these other VMs based on its load balancing algorithm.

Subsequently, as depicted in FIG. 6D, host D and host E are removed from cluster 61. Two hosts are removed in this example, not three, because the cluster utilization is assumed to have increased during the upgrade process. In addition, host D and host E are removed without upgrading them first.

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The terms computer readable medium or non-transitory computer readable medium refer to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Certain embodiments as described above involve a hardware abstraction layer on top of a host computer. The hardware abstraction layer allows multiple contexts to share the hardware resource. These contexts can be isolated from each other, each having at least a user application running therein. The hardware abstraction layer thus provides benefits of resource isolation and allocation among the contexts. Virtual machines may be used as an example for the contexts and hypervisors may be used as an example for the hardware abstraction layer. In general, each virtual machine includes a guest operating system in which at least one application runs. It should be noted that, unless otherwise stated, one or more of these embodiments may also apply to other examples of contexts, such as containers. Containers implement operating system-level virtualization, wherein an abstraction layer is provided on top of a kernel of an operating system on a host computer or a kernel of a guest operating system of a VM. The abstraction layer supports multiple containers each including an application and its dependencies. Each container runs as an isolated process in user-space on the underlying operating system and shares the kernel with other containers. The container relies on the kernel's functionality to make use of resource isolation (CPU, memory, block I/O, network, etc.) and separate namespaces and to completely isolate the application's view of the operating environments. By using containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific configurations. Other allocations of functionality are envisioned and may fall within the scope of the appended claims. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of upgrading a cluster of hosts that are running workloads, at least one of which is designated as critical, said method comprising:
(a) adding a host that has been upgraded to the cluster of hosts;
(b) selecting one of the hosts for upgrade;
(c) determining whether any of the workloads running in the selected host are designated as critical;
(d) migrating all of the workloads from the selected host that are designated as critical to the added host; and
(e) migrating each of the workloads from the selected host that are not designated as critical to a selected one of the hosts of the cluster.

2. The method of claim 1, further comprising:
upgrading the selected host;
selecting another one of the hosts for upgrade;
determining whether any of the workloads running in the selected another host are designated as critical;
migrating each of the workloads from the selected another host that are designated as critical to a selected one of the hosts of the cluster that have been upgraded; and
migrating each of the workloads from the selected another host that are not designated as critical to a selected one of the hosts of the hosts.

3. The method of claim 1, further comprising:
determining that one of the workloads to be migrated from the selected another host is a workload of an active-passive pair, wherein
when migrating the workload of the active-passive pair from the selected another host, the selection of one of the hosts as a migration destination is made from a group of hosts that exclude the host in which the other workload of the active-passive pair is running.

4. The method of claim 1, wherein
when migrating each of the workloads from the selected another host that are designated as critical, the selection of one of the hosts that have been upgraded as a migration destination is made to achieve load balancing across the hosts that have been upgraded.

5. The method of claim 4, wherein
when migrating each of the workloads from the selected another host that are not designated as critical, the selection of one of the hosts of the cluster as a migration destination is made to achieve load balancing across all of the hosts of the cluster.

6. The method of claim 1, further comprising:
notifying each of the workloads running in the selected host that are designated as critical to prepare for migration before the host that has been upgraded is added to the cluster.

7. The method of claim 1, wherein
the hosts of the cluster include first hosts located in a first availability zone and second hosts located in a second availability zone, and
steps (a)-(e) are carried out concurrently in each of the first and second availability zones.

8. The method of claim 7, further comprising:
determining that virtual machines executing a clustered application are running in the first and second hosts, wherein
in step (b) carried out in the second availability zone, one of the second hosts is selected for upgrade depending on which one of the first hosts is selected for upgrade in step (b) carried out in the first availability zone.

9. The method of claim 8, wherein
the second host selected for upgrade does not have any of the virtual machines executing the clustered application running therein if the first host selected for upgrade has one of the virtual machines executing the clustered application running therein.

10. A non-transitory computer readable medium comprising instructions to be executed in a computer system to carry out a method of upgrading a cluster of hosts that are running workloads, at least one of which is designated as critical, said method comprising:
(a) adding a host that has been upgraded to the cluster of hosts;
(b) selecting one of the hosts for upgrade;
(c) determining whether any of the workloads running in the selected host are designated as critical;
(d) migrating all of the workloads from the selected host that are designated as critical to the added host; and
(e) migrating each of the workloads from the selected host that are not designated as critical to a selected one of the hosts of the cluster.

11. The non-transitory computer readable medium of claim 10, wherein the method further comprises:
upgrading the selected host;
selecting another one of the hosts for upgrade;
determining whether any of the workloads running in the selected another host are designated as critical;
migrating each of the workloads from the selected another host that are designated as critical to a selected one of the hosts of the cluster that have been upgraded; and
migrating each of the workloads from the selected another host that are not designated as critical to a selected one of the hosts of the hosts.

12. The non-transitory computer readable medium of claim 10, wherein the method further comprises:
determining that one of the workloads to be migrated from the selected another host is a workload of an active-passive pair, wherein
when migrating the workload of the active-passive pair from the selected another host, the selection of one of the hosts as a migration destination is made from a group of hosts that exclude the host in which the other workload of the active-passive pair is running.

13. The non-transitory computer readable medium of claim 10, wherein
when migrating each of the workloads from the selected another host that are designated as critical, the selection of one of the hosts that have been upgraded as a migration destination is made to achieve load balancing across the hosts that have been upgraded.

14. The non-transitory computer readable medium of claim 13, wherein
when migrating each of the workloads from the selected another host that are not designated as critical, the selection of one of the hosts of the cluster as a migration destination is made to achieve load balancing across all of the hosts of the cluster.

15. The non-transitory computer readable medium of claim 10, wherein the method further comprises:
notifying each of the workloads running in the selected host that are designated as critical to prepare for migration before the host that has been upgraded is added to the cluster.

16. The non-transitory computer readable medium of claim 10, wherein
the hosts of the cluster include first hosts located in a first availability zone and second hosts located in a second availability zone, and
steps (a)-(e) are carried out concurrently in each of the first and second availability zones.

17. The non-transitory computer readable medium of claim 16, wherein the method further comprises:
determining that virtual machines executing a clustered application are running in the first and second hosts, wherein
in step (b) carried out in the second availability zone, one of the second hosts is selected for upgrade depending on which one of the first hosts is selected for upgrade in step (b) carried out in the first availability zone.

18. The non-transitory computer readable medium of claim 17, wherein
the second host selected for upgrade does not have any of the virtual machines executing the clustered application running therein if the first host selected for upgrade has one of the virtual machines executing the clustered application running therein.

19. A cloud platform for managing a method of upgrading a cluster of hosts that are running workloads, at least one of which is designated as critical, wherein the cloud platform includes a processor that is programmed to carry out the steps of:
(a) adding a host that has been upgraded to the cluster of hosts;
(b) selecting one of the hosts for upgrade;
(c) determining whether any of the workloads running in the selected host are designated as critical;
(d) migrating all of the workloads from the selected host that are designated as critical to the added host; and
(e) migrating each of the workloads from the selected host that are not designated as critical to a selected one of the hosts of the cluster.

20. The cloud platform of claim 19, wherein the steps further comprise:
notifying each of the workloads running in the selected host that are designated as critical to prepare for migration before the host that has been upgraded is added to the cluster.
